(19) United States
(12) Patent Application Publication
(10) Pub. No.: US 2020/0150649 A1
(43) Pub. Date: May 14, 2020

(54) METHOD OF AUTOMATED CONTROL OF DRONE DEVICES

(71) Applicants: Jayanta L Barua, (US); Viral Shah, Cumming, GA (US)

(72) Inventors: Jayanta L. Barua, Brentwood, TN (US); Viral Shah, Cumming, GA (US)

(21) Appl. No.: 16/676,505

(22) Filed: Nov. 7, 2019

Related U.S. Application Data
(60) Provisional application No. 62/757,736, filed on Nov. 8, 2018.

(51) Int. Cl. G05D 1/00; B64C 39/02; G06Q 10/10

(52) U.S. Cl. CPC G05D 1/0038; B64C 39/024; B64C 2201/141; B64C 2201/127; G06Q 10/10

(57) ABSTRACT

Systems and methods disclosed herein can facilitate an automated control of drone devices. In an aspect, disclosed is a computer-implemented method, that includes assigning, by a system communicatively coupled to one or more processor, a claim for evaluation or adjudication. Furthermore, the computer-implemented method also includes tagging, by the system, claim data with adjudicator identification data, wherein the set of claim data comprises at least policy identification data. In another aspect, the method includes activating, by the system, one or more drone device to perform a media content data generation operation, wherein the media content data comprises at least one of image data, audio data, geolocation data, or video data.

### CROSS-REFERENCE

This application claims priority to U.S. Patent Application No. 62/757,736 titled, METHOD OF AUTOMATED CONTROL OF DRONE DEVICES AND DRONE DATA PROCESSING” and filed on Nov. 8, 2018. The entirety of the disclosures of the aforementioned applications are considered part of, and is incorporated by reference in, the disclosure of this application.

### TECHNICAL FIELD

This application relates to systems and methods for operating, controlling and flying drones as well as analyzing, processing and curating data captured from drone operations.

### BACKGROUND

Improvements are needed to antiquated processes of gathering and processing data related to insurance transactions, survey automation and claim adjudication.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

This specification relates to systems and methods to process sets of data corresponding to insurable events and generated at least in part by drone devices. In accordance with one non-limiting implementation, disclosed is a method, comprising at 1 at least one processor to execute computer executable components stored in a memory to perform the following acts: assigning, by a user device comprising a processor, a claim for evaluation or adjudication; tagging, by the user device, claim data with adjudicator identification data, wherein the set of claim data comprises at least policy identification data; activating, by the user device, one or more drone device to perform a media content data generation operation, wherein the media content data comprises at least one of image data, audio data, geolocation data, or video data; transmitting, by the user device, the media content data to one or more server device; and mapping, by a server device, the media content data to the tagged claim data.

In a non-limiting embodiment, the computer-implemented method can also comprise routing, by a system comprising a processor, the claim data to a fourth application executing on a target user device of a set of user devices based on a comparison of first geo-location data corresponding to the target user device and second geo-locational data corresponding to the claim data. Furthermore, the computer-implemented method can further comprise analyzing, by a fifth application executing on another user device, Key Performance Indicators (KPI) data, estimation data, the claim data, the media content data, the tagged claim data, or the policy identification data for data insights.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a block diagram of an example, non-limiting computer-implemented method 100 that can facilitate an automated control of drone devices and drone data processing operations in accordance with one or more embodiments described herein.

FIG. 2 illustrates a block diagram of an example, non-limiting operating environment 200 in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, disclosed is one or more platform system that can be deployed over a cloud-based environment to facilitate the generation of data to satisfy threshold data requirements of various rule sets (e.g., survey rules and claim rules within various industries. For instance, organizations within the insurance, real estate, and manufacturing sectors can utilize the platform systems and methods disclosed herein to complete survey processes and requirements tied insurance claims. Furthermore, the systems can utilize drones' devices to facilitate data generation thereby reducing the risk and dangers to people used to access difficult and dangerous incident locations. In many instances, drone devices can capture the necessary data that are impossible for people to collect.

In an aspect, the systems, methods and process can include the following non-limiting use case. A first user device corresponding to an organization can utilize the system communicatively coupled to at least one processor to identify and register and on-board user profiles (e.g., representing insurance adjusters) executing on second user devices via the system platform (e.g., Triton Drona™ Software platform). The system platform (e.g., using Drona™ GoWeb Application) can be used by the first user device (e.g., owned by insurance companies) to assign claim data (e.g., representing insurance claims) to second user devices (e.g., adjusters) to perform survey activities. Once claims are assigned to individual second user devices, the claim data can be tagged to claim identification data and policy identification data (e.g., policy number) and will appear on an application (e.g., using Drona™ Companion Application) executing on the second user device. Thus, the system can assign the tagged claim data to adjuster identifier data.

Furthermore, second user devices can use an application (e.g., Drona™ Companion Application) to operate the Drones either on a manual or an automatic flight mission to take pictures (e.g., using camera devices) and videos (e.g., using video capture devices) of claims incidents. In an aspect, systems and methods disclosed herein can facilitate the operating, controlling and flying of drone devices as well as analyze, process and curate data captured from the drone operations. For instance, if a roof of a building is damaged from inclement weather, the systems disclosed herein can control a drone device to make several flight passes over the roof in an accurate manner based on machine learning insights (e.g., patterns, trends) that point to similar damage noticed on experiences with roof damage on homes, weather, etc. with similar characteristics to the current event and evaluating that historical data via machine learning algorithms (as applied to the assessment process).

Once these missions are complete for each claim, the adjuster can upload the geo-tagged images/videos along with its policy and claims information to a cloud infrastructure. The data stored on the cloud (e.g., data stores) thus provides a complete data set representing items such as claims identifier information, policy identifier information, geographic location information, images data, video data, and other such data for the user (e.g., owned by an insurance company) to complete the initial claim estimation operation. In an aspect, the platform system (e.g., Drona™ platform) with its image processing and machine learning algorithms provides the ability for this information to be stored on the cloud or via on-premise server devices.

In another aspect, the system can employ one or more algorithm (e.g., Drona™ Proximity incident Algorithm (PiA), machine learning algorithms, etc.) that provide unique routing capabilities that can facilitate performance of a set of microservice operations representing a routing of claim incidents to respective devices (e.g., registered Drona™). In another aspect, second user devices (e.g., owned by independent adjusters) can employ system components that can correlate proximity of second user devices (e.g., owned by adjusters) to location data representing locations of incidents and allow these second user devices to lock into these “claims” calls and service them as soon as they happen.

This is a powerful algorithm that will ultimately change the way user devices (e.g., owned by insurance companies) use technologies to detect and ultimately fight damages arising out of natural and man-made catastrophic events like forest fire, hurricanes, hail damage, roof damages, wind etc. quickly and humanely. Further details of individual components of this architecture and algorithms are disclosed in the U.S. Provisional application (e.g., in the appendix) to which this application and disclosure claims priority. In another aspect, the system can employ analytic components (e.g., Drona™ Analytics) that can provide important dashboards with claims mission details and Key Performance Indicators for organizations (e.g., insurance companies) to assess the effectiveness of a drone device driven claims survey and estimation process.

In an aspect, the disclosed systems can employ technologies such as Drona™ Software Platform, The Drona™ Companion Application, Internal Cloud development technologies for Adjuster Registration, and Assignment and Drona™ Proximity Incident Algorithm (PiA).

In another aspect, the systems and methods disclosed herein bring together a variety of modern technologies like Internet of Things (IOT), Cloud Computing and Insurance business processes in a simple, elegant and easy to use software platform to ultimately provide Insurance and Manufacturing companies a technology eco-system to survey and estimate claims incidents in a manner that is safe for human beings. In a non-limiting aspect, using drones with the platform system will make the claims adjudication process accurate, consistent, quick, cost effective to customers.

In another aspect, the U.S. Provisional application (e.g., in the appendix) to which this application and disclosure claims priority discloses architecture diagrams and components of the Drona™ Software Platform technology. In a non-limiting embodiment, the platform implements the Drona™ Proximity Incident Algorithm (PiA) compromising of four microservices such as Addr-2-Geo, which is a microservice that can take JSON response with one of the keys having incident/property address and the service uses Google Geo APIs to convert into latitude and longitude information. Furthermore, the platform can comprise Prox-2-Loc which can be a master microservice that monitors incoming claims data and incident data and periodically updates the incident to agent/station proximity for algorithm to work. Furthermore, the system can comprise AppLoc-2Geo that is a microservice that can keep track of all registered field adjusters/stations every 240 seconds (configurable). Later this detail is used in the algorithm. In yet another aspect, the platform can comprise Prox-2-Incident that can comprise a microservice that will talk to Prox-2-Loc master service and will provide Google Maps API pin array to mobile clients to display on the client map object.

In another aspect, the systems can be utilized by insurance companies, manufacturing companies, defense and government sector organizations, independent adjusters, software companies providing insurance products and services to insurance companies.

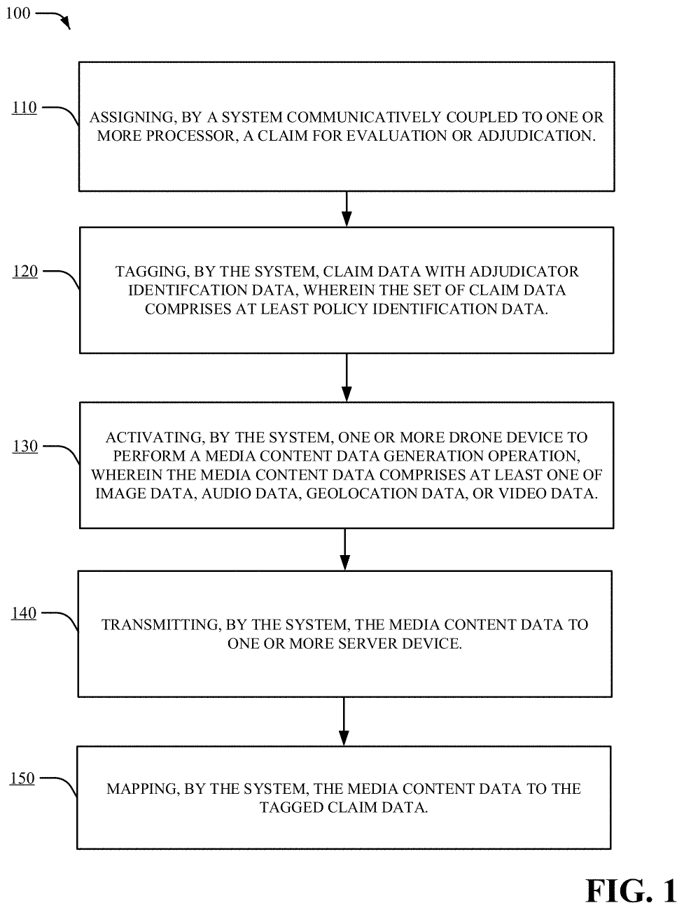

Referring now to FIG. 1 illustrates a block diagram of an example, non-limiting computer-implemented method 100 that can facilitate an automated control of drone devices and drone data processing operations in accordance with one or more embodiments described herein.

In an aspect, one or more of the components described in computer-implemented method 100 can be electronically and/or communicatively coupled to one or more devices. Repetitive description of like elements employed in other embodiments described herein is omitted for sake of brevity. In some implementations, at reference numeral 110, a system operatively coupled to one or more processor can assign a claim for evaluation or adjudication. At reference numeral 120, the system can tag claim data with adjudicator identification data, wherein the set of claim data comprises at least policy identification data. At reference numeral 130, the system can activate one or more drone device to perform a media content data generation operation, wherein the media content data comprises at least one of image data, audio data, geolocation data, or video data. At reference numeral 140, the system can transmit the media content data to one or more server device. At reference numeral 150, the system can map the media content data to the tagged claim data.

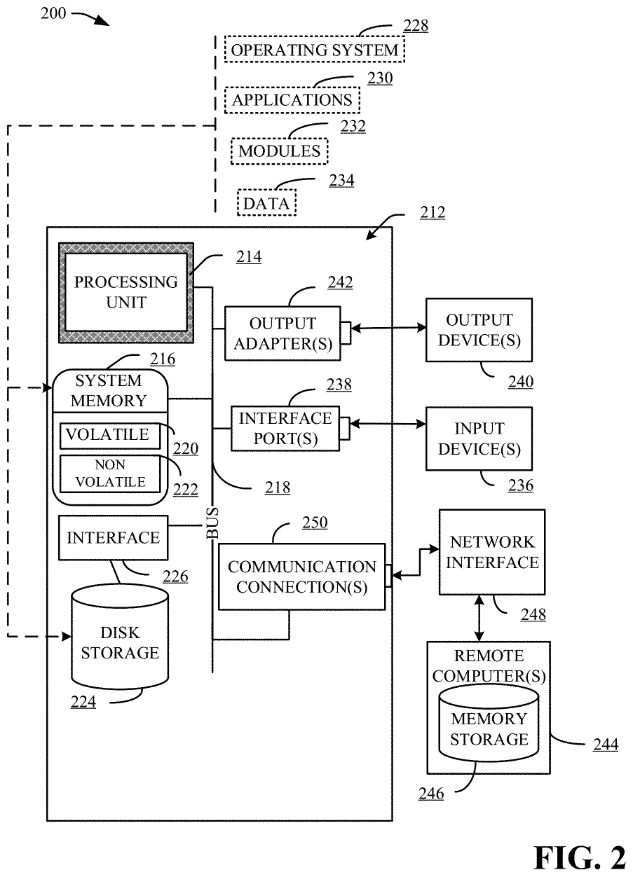

In order to provide a context for the various aspects of the disclosed subject matter, FIG. 2 as well as the following discussion is intended to provide a general description of a suitable environment in which the various aspects of the disclosed subject matter can be implemented. FIG. 2 illustrates a block diagram of an example, non-limiting operating environment in which one or more embodiments described herein can be facilitated. With reference to FIG. 2, a suitable operating environment 200 for implementing various aspects of this disclosure can also include a computer 212. The computer 212 can also include a processing unit 214, a system memory 216, and a system bus 218. The system bus 218 couples system components including, but not limited to, the system memory 216 to the processing unit 214. The processing unit 214 can be any of various available processors. Dual microprocessors and other multiprocessor architectures also can be employed as the processing unit 214. The system bus 218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 216 can also include volatile memory 220 and nonvolatile memory 222. The basic input/output system (BIOS), containing the basic routines to transfer information between elements within the computer 212, such as during start-up, is stored in nonvolatile memory 222. By way of illustration, and not limitation, nonvolatile memory 222 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 220 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 212 can also include removable/non-removable, volatile/non-volatile computer storage media. FIG. 2 illustrates, for example, a disk storage 224. Disk storage 224 can also include, but is not limited to, devices like a magnetic disk drive, floppy disk drive, tape drive, Jaz drive, Zip drive, LS-100 drive, flash memory card, or memory stick. The disk storage 224 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 224 to the system bus 218, a removable or non-removable interface is typically used, such as interface 226. FIG. 2 also depicts software that acts as an intermediary between users and the basic computer resources described in the suitable operating environment 200. Such software can also include, for example, an operating system 228. Operating system 228, which can be stored on disk storage 224, acts to control and allocate resources of the computer 212.

System applications 230 take advantage of the management of resources by operating system 228 through program modules 232 and program data 234, e.g., stored either in system memory 216 or on disk storage 224. It is to be appreciated that this disclosure can be implemented with various operating systems or combinations of operating systems. A user enters commands or information into the computer 212 through input device(s) 236. Input devices 236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 214 through the system bus 218 via interface port(s) 238. Interface port(s) 238 include, for example, a serial port, a parallel port, a game port, and a universal serial bus (USB). Output device(s) 240 use some of the same type of ports as input device(s) 236. Thus, for example, a USB port can be used to provide input to computer 212, and to output information from computer 212 to an output device 240. Output adapter 1242 is provided to illustrate that there are some output device 240 like monitors, speakers, and printers, among other such output device 240, which require special adapters. The output adapters 242 include, by way of illustration and not limitation, video and sound cards that provide a means of connection between the output device 240 and the system bus 218. It should be noted that other devices and/or systems of devices provide both input and output capabilities such as remote computer(s) 244.

Computer 212 can operate in a networked environment using logical connections to one or more remote computers, such as remote computer(s) 244. The remote computer(s) 244 can be a computer, a server, a router, a network PC, a workstation, a microprocessor based appliance, a peer device or other common network node and the like, and typically can also include many or all of the elements described relative to computer 212. For purposes of brevity, only a memory storage device 246 is illustrated with remote computer(s) 244. Remote computer(s) 244 is logically connected to computer 212 through a network interface 248 and then physically connected via communication connection 250. Network interface 248 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 250 refers to the hardware/software employed to connect the network interface 248 to the system bus 218. While communication connection 250 is shown for illustrative clarity inside computer 212, it can also be external to computer 212. The hardware/software for connection to the network interface 248 can also include, for exemplary purposes only, internal and external technologies such as, modems including regular telephone grade modems, cable modems and DSL modems, ISDN adapters, and Ethernet cards.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computer, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAIVI). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAIVI), Synchlink DRAM (SLDRAIVI), direct Rambus RAM (DRRAIVI), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
assigning, by a system communicatively coupled to one or more processor, a claim for evaluation or adjudication;
tagging, by the system, claim data with adjudicator identification data, wherein the set of claim data comprises at least policy identification data;
activating, by the system, one or more drone device to perform a media content data generation operation, wherein the media content data comprises at least one of image data, audio data, geolocation data, or video data;
transmitting, by the system, the media content data to one or more server device; and
mapping, by the system, the media content data to the tagged claim data.

2. The computer-implemented method of claim 1, further comprising:
routing, by the system, the claim data to a fourth application executing on a target user device of a set of user devices based on a comparison of first geo-location data corresponding to the target user device and second geo-locational data corresponding to the claim data.

3. The computer-implemented method of claim 1, further comprising:
analyzing, by the system, KPI data, estimation data, the claim data, the media content data, the tagged claim data, or the policy identification data for data insights.
